(19) United States
(12) Patent Application Publication
(10) Pub. No.: US 2006/0076929 A1
(43) Pub. Date: Apr. 13, 2006

(54) Method of detecting state-of-charge of battery and power device

(76) Inventors: Hiroshi Tatsumi, Kakogawa-city (JP); Yutaka Yamauchi, Himeji-city (JP); Fumio Yasutomi, Kobe-city (JP); Shinya Inui, Kokogawa-city (JP)

Correspondence Address: WENDEROTH, LIND & PONACK, L.L.P., 2033 K STREET N. W., SUITE 800, WASHINGTON, DC, 20006-1021, US

(21) Appl. No.: 11/246,094

(22) Filed: Oct. 11, 2005

(30) Foreign Application Priority Data
Oct. 12, 2004 (JP) 297043/2004

(51) Int. Cl. H02J 7/00

(52) U.S. Cl. 320/132

(57) ABSTRACT

A method of detecting a state-of-charge of a battery detects a current of a battery and a voltage of the battery, calculating a state-of-charge of the battery as a first state-of-charge based on an integration of the current of the battery thus detected, while calculating the state-of-charge of the battery as a second state-of-charge based on the voltage of the battery and calculating a synthetic state-of-charge obtained by taking a weighted mean of the first state-of-charge and the second state-of-charge as the state-of-charge of the battery, and weighting the weighted mean in order to increase weighting of the second state-of-charge in a region in which a capacity of the battery is increased and a region in which the capacity of the battery is reduced and to increase weighting of the first state-of-charge in other regions.

### BACKGROUND OF THE INVENTION

1. Field of the Invention

The present invention relates to a method of detecting a state-of-charge of a battery and a power device, and more particularly to a state-of-charge detecting method of detecting a state-of-charge of a battery included in a power device for driving a vehicle operating motor and the power device, for example.

2. Description of the Related Art

The power device can increase the number of power modules having a battery or a simple battery connected in series or in parallel and can thus increase an output current, and can raise an output voltage depending on the number of the batteries connected in series. In a power device to be used for requiring a large output, for example, in a power device to be used for a vehicle such as a car, a bicycle or a tool, particularly, it is possible to employ a structure in which a plurality of batteries is connected in series to increase an output. For example, in a power supply for a large current and a large output which is used in a power device for a vehicle to be operated by a motor, for example, a hybrid car or a fuel battery car, a power module having a plurality of batteries connected in series is further connected in series to raise an output voltage. The reason is that the output of a driving motor is to be increased.

In such a power device, it is important that an output is limited to use a battery in a safe condition in order to continuously use the battery with a high reliability. For example, when an overdischarge or an overcharge is generated, the lifetime of the battery is reduced. For this reason, the state-of-charge (SOC) of the battery is detected and a quantity of a power which can be used in the discharge and charge of the battery is limited correspondingly. The state-of-charge of the battery is generally detected by subtracting a discharge capacity in a full charging state. The discharge capacity is calculated by integrating a discharge current. The state-of-charge of the battery is displayed as a product of a current and a time, that is, Ah or can be represented as a ratio (%) to a full charging capacity, wherein a full charged capacity (Ah) is set to be 100%. Even if the state-of-charge is displayed in any state, a discharged capacity is subtracted in the full charging state and the state-of-charge is thus detected. The state-of-charge detected with the integrated value of a discharge current is not always coincident with a correct state-of-charge of the battery. The reason is that the magnitude and temperature of the discharge current makes an error of the detection of the state-of-charge.

While there is also a method of measuring a voltage of a battery to detect the state-of-charge of the battery, moreover, it is impossible to uniquely determine the state-of-charge by this method. It has been known that a different voltage is detected depending on a past charge/discharge history or the like in the same state-of-charge. It is hard to accurately presume the state-of-charge from only the voltage of the battery.

Thus, it is hard to accurately detect the state-of-charge of the battery. With the same current and the same voltage value, the quantity of a power which can be used is varied depending on the state-of-charge, the temperature of the battery or the like. When a so-called memory effect is generated, particularly, the capacity of the battery is substantially reduced. For this reason, it is more difficult to detect the state-of-charge. The memory effect is a phenomenon in which a discharge voltage is temporarily reduced in a deep discharge in the case in which a nickel-cadmium battery, a nickel-hydrogen battery or the like is cycle charged/discharged in a small discharge depth. The state-of-charge of the battery is changed by the memory effect. Consequently, it is impossible to estimate the accurate state-of-charge of the battery. In some cases in which the state-of-charge is detected erroneously, an excessively loaded operation is carried out in the charge/discharge of the battery, causing a remarkable reduction in the lifetime of the battery. On the other hand, the state-of-charge is also changed by the self-discharge of the battery. By these factors, it is hard to guess the state-of-charge of the battery. Consequently, it is very difficult to grasp an accurate state-of-charge (see Japanese Laid-Open Patent Publication No. Sho 56-126776).

### SUMMARY OF THE INVENTION

The present invention has been made in order to solve these problems. It is a main object of the present invention to provide a method of detecting a state-of-charge of a battery which can detect the state-of-charge of a battery more accurately, and a power device.

In order to attain the object, a first aspect of the present invention is directed to a method of detecting a state-of-charge of a battery which detects a state-of-charge of a battery included in a power device when supplying a power from the battery to connecting equipment connected to the power device, comprising the steps of detecting a current of the battery and a voltage of the battery, calculating a state-of-charge of the battery as a first state-of-charge based on an integration of the current of the battery which is detected, while calculating the state-of-charge of the battery as a second state-of-charge based on the voltage of the battery, and calculating, as a state-of-charge of the battery, a synthetic state-of-charge obtained by taking a weighted mean of the first state-of-charge and the second state-of-charge. Consequently, it is possible to synthesize the first state-of-charge based on the current of the battery with the second state-of-charge based on the voltage of the battery to estimate the state-of-charge of the battery. Thus, it is possible to estimate the state-of-charge more accurately.

Moreover, a second aspect of the present invention is directed to the method of detecting a state-of-charge of a battery, wherein a weighted mean is weighted in such a manner that weighting of the second state-of-charge is increased in a region in which a capacity of the battery is increased and a region in which the capacity of the battery is reduced, and weighting of the first state-of-charge is increased in other regions. Consequently, it is possible to estimate the state-of-charge with comparatively high precision based on a voltage in a region in which the state-of-charge is high in charging and a region in which the state-of-charge is low in discharging. On the other hand, higher precision can be maintained in the estimation of the state-of-charge based on the integration of the current than the detection of the state-of-charge based on the voltage in the case in which the state-of-charge is in the vicinity of 50%. By utilizing such a characteristic, it is possible to implement an excellent feature that the state-of-charge can be estimated with high precision in all regions by an increase in the weighting in a region in which precision in the estimation of the state-of-charge is high.

Furthermore, a third aspect of the present invention is directed to the method of detecting a state-of-charge of a battery, comprising the step of detecting a measuring time of the current of the battery and a temperature of the battery, the first state-of-charge being calculated by accumulating a value obtained by multiplying a quantity of electricity obtained by multiplying a battery current value by the measuring time by a charge efficiency determined by the temperature of the battery and a past state-of-charge. Consequently, it is possible to calculate the first state-of-charge based on the current of the battery with high precision which takes a past state-of-charge and the current of the battery into consideration.

In addition, a fourth aspect of the present invention is directed to the method of detecting a state-of-charge of a battery, wherein the second state-of-charge is determined by referring to a previously created table indicating a relationship between the voltage of the battery and the state-of-charge.

Moreover, a fifth aspect of the present invention is directed to the method of detecting a state-of-charge of a battery, further comprising the step of detecting a temperature of the battery, a plurality of different tables for determining the second state-of-charge being prepared corresponding to the temperature of the battery and/or a charge/discharge current value.

Furthermore, a sixth aspect of the present invention is directed to the method of detecting a state-of-charge of a battery, wherein a synthetic state-of-charge is calculated by taking a weighted mean in the following equation:
Synthetic residual quantity=((first state-of-charge*first weight)+(second state-of-charge*second weight))/(first weight+second weight)

Consequently, it is possible to estimate the state-of-charge with comparatively high precision based on a voltage in a region in which the state-of-charge is high in charging and a region in which the state-of-charge is low in discharging. On the other hand, higher precision can be maintained in the estimation of the state-of-charge based on the integration of the current than the detection of the state-of-charge based on the voltage in the case in which the state-of-charge is in the vicinity of 50%. By utilizing such a characteristic, it is possible to implement an excellent feature that the state-of-charge can be estimated with high precision in all regions by an increase in the weighting in a region in which precision in the estimation of the state-of-charge is high.

In addition, a seventh aspect of the present invention is directed to the method of detecting a state-of-charge of a battery, wherein connecting equipment is an on-vehicle motor and a state-of-charge of a battery included in a power device for driving the on-vehicle motor is detected. Consequently, it is possible to suitably utilize the detecting method for detecting the state-of-charge of the battery in an on-vehicle power device.

Moreover, an eighth aspect of the present invention is directed to a power device comprising a battery unit 20 including a plurality of secondary batteries, a voltage detecting portion 12 for detecting a voltage of the secondary battery included in the power unit 20, a temperature detecting portion 14 for detecting a temperature of the secondary battery included in the power unit 20, a current detecting portion 16 for detecting a current flowing to the secondary battery included in the battery unit 20, a state-of-charge calculating portion 18 for calculating signals to be input from the voltage detecting portion 12, the temperature detecting portion 14 and the current detecting portion 16 and detecting a state-of-charge of the secondary battery, and a communication processing portion 19 for transmitting the state-of-charge calculated by the state-of-charge calculating portion 18 to connecting equipment, the state-of-charge calculating portion 18 increasing weighting of a second state-of-charge in a region in which a state-of-charge is increased and a region in which the state-of-charge is reduced and increasing weighting of a first state-of-charge in other regions when integrating the charge/discharge current detected by the current detecting portion 16 to calculate the first state-of-charge, while calculating the second state-of-charge based on the voltage of the battery which is detected by the voltage detecting portion 12 and taking a weighted mean of the first state-of-charge and the second state-of-charge to calculate a synthetic state-of-charge as the state-of-charge of the battery. Consequently, it is possible to estimate the state-of-charge with comparatively high precision based on a voltage in a region in which the state-of-charge is high in charging and a region in which the state-of-charge is low in discharging. On the other hand, higher precision can be maintained in the estimation of the state-of-charge based on the integration of the current than the detection of the state-of-charge based on the voltage in the case in which the state-of-charge is in the vicinity of 50%. By utilizing such a characteristic, it is possible to implement an excellent feature that the state-of-charge can be estimated with high precision in all regions by an increase in the weighting in a region in which precision in the estimation of the state-of-charge is high.

The state-of-charge detecting method and the power device described above can implement an excellent feature that the state-of-charge of the battery can be detected with high precision over the whole region of the battery capacity. The reason is that the state-of-charge is estimated based on the voltage of the battery in addition to the estimation of the state-of-charge through the integration of the current and these are synthesized to determine the state-of-charge. In the method of estimating the state-of-charge based on the voltage of the battery, particularly, high precision can be obtained in the region in which the capacity of the battery is large and the region in which the capacity of the battery is small. On the other hand, high precision can be obtained in the estimation of the state-of-charge based on the integration of the current in the middle region having a capacity of 50%. The weighting is changed corresponding to the capacity of the battery, and a weighted mean is obtained in such a manner that the specific gravity of the estimation of the capacity based on the voltage is increased in the regions having large and small capacities and the specific gravity of the estimation of the capacity based on the integration of the current is increased in the middle region. Thus, it is possible to calculate the state-of-charge of the battery with high precision over the whole region of the capacity of the battery.

The above and further objects and features of the invention will more fully be apparent from the following detailed description with accompanying drawings.

### BRIEF DESCRIPTION OF THE DRAWINGS

FIG. 1 is a block diagram showing a structure of a power device according to an embodiment of the present invention;

FIG. 2 is a graph showing a relationship between a voltage of a battery and a state-of-charge;

FIG. 3 is a graph for explaining a region in which a first state-of-charge and a second state-of-charge are influenced in a calculation for a synthetic state-of-charge;

FIG. 4 is a graph representing a relationship between first and second weights and a state-of-charge in the case in which the synthetic state-of-charge is to be calculated, and;

FIG. 5 is a graph representing a relationship between the first weight and the second weight for a second state-of-charge.

### DETAILED DESCRIPTION OF THE PREFERRED EMBODIMENTS

(Power Device 100)

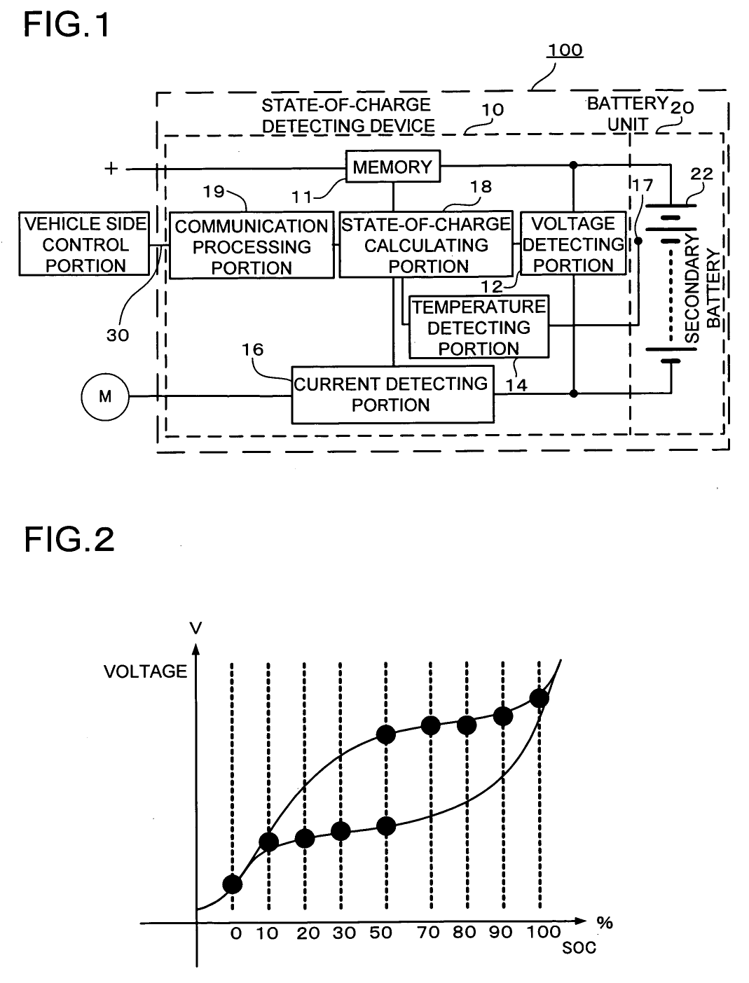

FIG. 1 is a block diagram showing a structure of a power device according to an embodiment of the present invention. A power device 100 shown in FIG. 1 comprises a battery unit 20 including a secondary battery 22 and a state-of-charge detecting device 10. The state-of-charge detecting device 10 includes a voltage detecting portion 12 for detecting a voltage of a battery, a temperature detecting portion 14 for detecting a temperature of the battery, a current detecting portion 16 for detecting a current flowing to the battery, a state-of-charge calculating portion 18 for calculating signals input from the voltage detecting portion 12, the temperature detecting portion 14 and the current detecting portion 16 to detect a state-of-charge of the battery and detecting a maximum limit current value of the battery unit 20 from the state-of-charge and the temperature of the battery, and a communication processing portion 19 for transmitting, to connecting equipment, the state-of-charge and the maximum limit current value which are calculated. The communication processing portion 19 is connected to a connecting equipment communication terminal 30. The communication processing portion 19 is connected to the connecting equipment through the connecting equipment communication terminal 30 and transmits signals indicative of a state-of-charge and a maximum limit current value to the connecting equipment. In this example, a vehicle such as a car is used as the connecting equipment, and the power device 100 is mounted on the vehicle to drive a motor M for causing the vehicle to run. The communication processing portion 19 is connected to a vehicle side control portion provided on the vehicle and thus carries out a communication. Description will be given to the power device for the vehicle.

The secondary battery 22 provided in the battery unit 20 is a nickel hydrogen battery. The battery can also be a nickel cadmium battery or a lithium ion secondary battery. Moreover, at least one battery is connected in series, in parallel or in combination of the series and parallel connections. The battery is constituted by a module having a plurality of batteries coupled to each other. A plurality of modules is coupled to constitute the battery unit 20.

The voltage detecting portion 12 detects a voltage of the secondary battery 22 provided in the battery unit 20. The battery unit 20 shown in the drawing has a plurality of secondary batteries 22 connected in series. Consequently, the voltage detecting portion 12 detects a total voltage of the batteries connected in series. It is also possible to detect the voltage for each battery module constituting the battery unit 20. The voltage detecting portion 12 outputs the detected voltage as an analog signal to the state-of-charge calculating portion 18 or converts an analog signal into a digital signal by means of an A/D converter and outputs the digital signal to the state-of-charge calculating portion 18. The voltage detecting portion 12 detects the voltage of a battery in a constant sampling cycle or continuously and outputs the detected voltage to the state-of-charge calculating portion 18.

The temperature detecting portion 14 includes a temperature sensor 17 provided in the battery unit 20 and serving to detect the temperature of the battery. The temperature sensor 17 comes in contact with the surface of the battery, comes in contact with the battery through a thermal conductor or approaches the surface of the battery and is thermally coupled to the battery to detect the temperature of the battery. The temperature sensor 17 is a thermistor. All units capable of converting a temperature into an electrical resistance, for example, a PTC, a varistor and the like, can be used for the thermistor 17. Moreover, a unit capable of detecting an infrared ray radiated from the battery and detecting a temperature in a non-contact state with the battery can also be used for the temperature sensor 17. The temperature detecting portion 14 also outputs the detected battery temperature in an analog signal to the state-of-charge calculating portion 18 or converts the analog signal into a digital signal by the A/D converter to output the digital signal to the state-of-charge calculating portion 18. The temperature detecting portion 14 detects the temperature of the battery in a constant sampling cycle or continuously, and outputs the temperature of the battery thus detected to the state-of-charge calculating portion 18.

The current detecting portion 16 connects a resistive unit in series to the battery and detects a voltage induced to both ends of the resistive unit, and thus detects a discharge current flowing to the battery. The resistive unit is a resistor having a low resistance. A semiconductor such as a transistor or an FET can also be used for the resistive unit. The charge and discharge currents of the battery flow in opposite directions to each other. For this reason, positive and negative polarities induced to the resistive unit are inverted. Accordingly, the current can be decided to be the discharge current depending on the polarity of the resistive unit and the current can be thus detected with the voltage induced to the resistive unit. The reason is that the current is proportional to the voltage induced to the resistive unit. The current detecting portion 16 can accurately detect the discharge current of the battery. The current detecting portion 16 can also have such a structure as to detect a magnetic flux leaking out with a current flowing to a lead wire and to detect the current. The current detecting portion 16 also outputs the detected discharge current in an analog signal to the state-of-charge calculating portion 18 or converts an analog signal into a digital signal by the AID converter and outputs the digital signal to the state-of-charge calculating portion 18. The current detecting portion 16 detects the discharge current in a constant sampling cycle or continuously and outputs the detected discharge current to the state-of-charge calculating portion 18.

A device for outputting a signal having a digital value in a constant sampling cycle from the voltage detecting portion 12, the temperature detecting portion 14 and the current detecting portion 16 to the state-of-charge calculating portion 18 shifts a timing for outputting the digital signal from each of the detecting portions to the state-of-charge calculating portion 18 and outputs the digital signal to the state-of-charge calculating portion 18 in order.

(Method of Detecting State-of-charge of Battery)

In order to drive a vehicle by a power device, it is necessary to accurately detect the state-of-charge of the battery. The state-of-charge of the battery is generally calculated by detecting a charge current and a discharge current and integrating the detected current. In this method, the discharge current is subtracted from the charge current to calculate the state-of-charge. A charge capacity is calculated by integrating the charge current. A discharge capacity is calculated by integrating the discharge current. In a method of calculating a state-of-charge from the charge capacity and the discharge capacity, the state-of-charge can be calculated also in the case in which the secondary battery 22 is set to be a lithium ion battery, a nickel hydrogen battery or a nickel cadmium battery. The state-of-charge makes an error depending on a discharge current or a temperature of a battery. Accordingly, an accurate grasp is important.

In the present embodiment, an SOC is determined by the synthesis of two SOCs including a first state-of-charge (SOC1) calculated by the integration of a current and a second state-of-charge (SOC2) estimated by a voltage. These calculations are carried out in the state-of-charge calculating portion 18.

The state-of-charge calculating portion 18 integrates the discharge current of the battery and detects the discharge capacity, and subtracts the detected discharge capacity to calculate the first state-of-charge, and furthermore, calculates the second state-of-charge from the voltage of the battery as will be described below, and synthesizes the first state-of-charge with the second state-of-charge to calculate a synthetic state-of-charge. For example, when a battery having a full charge capacity of 1000 mAh is discharged in 500 mAh, a state-of-charge of 50% is obtained. When the battery charged fully is discharged, accordingly, the state-of-charge is gradually reduced. Moreover, the state-of-charge calculating portion 18 stores a value, data, setting and the like which are required for calculating the first state-of-charge and the second state-of-charge in a memory 11 connected to the state-of-charge calculating portion 18. A nonvolatile memory such as an E²PROM or a volatile memory such as an RAM can be utilized for the memory 11.

(First State-of-Charge)

The first state-of-charge is obtained by the integration of a current. The state-of-charge calculating portion 18 measures a current value, a voltage value and a temperature of the battery at a predetermined time interval (a sampling time) and calculates the state-of-charge based on them. In this example, a quantity of electricity obtained by multiplying a current value measured in the current detecting portion by a measuring time (sampling time) is further multiplied by a charge efficiency determined by the temperature of the battery and a last SOC value, and a value thus obtained is accumulated to calculate the first state-of-charge.
SOC1=(last SOC1)+((measured current value)*(current measuring time)*(charge efficiency))

In the present embodiment, the charge efficiency is set to be one in discharging and is set to be one in a low SOC region at a low temperature, and is set to have a smaller value than one in a high SOC region or at a high temperature in charging.

(Second State-of-Charge)

On the other hand, the second state-of-charge is estimated from a voltage. In this example, the second state-of-charge is obtained from the voltage of the battery which is measured in the voltage detecting portion by using an LUT (Look Up Table) indicating a relationship between the voltage of the battery and the SOC.

In the LUT, a discharge side has a voltage of SOC 0%, 10%, 20%, 30% and 50%, and the voltage of the battery which is higher is set to be SOC 50%. The reason is as follows. In the driving operation of the power device for a vehicle according to the present example, a charge/discharge is controlled in such a manner that the SOC of the battery is in the vicinity of 50%. A relationship between the voltage of the battery and the SOC has comparatively high precision in the case in which a discharging state is continuously set for a long time and the case in which a charging state is continuously set for a long time. Usually, the SOC is controlled to be in the vicinity of 50% so that the SOC in the discharge is 0 to 30%. Consequently, the discharge is continuously set for a long time. Thus, the relationship between the voltage of the battery and the SOC has high precision. Referring to the voltage of the battery which is higher than SOC 50% in the discharge, the discharge is carried out after the charge in the charging/discharging state. Consequently, the discharging state is set for a short period and the precision in the relationship between the voltage of the battery and the SOC is reduced. For this reason, the SOC 50% is set uniformly. In such a case, even if the second state-of-charge is uniformly set to be the SOC 50%, the weight of the second state-of-charge is small so that a great difference from an actual state-of-charge is made with difficulty.

Moreover, a charge side has a voltage of SOC 50%, 70%, 80%, 90% and 100%, and the voltage of the battery which is lower is set to be SOC 50%. The reason is as described above. Usually, the SOC is controlled to be in the vicinity of 50% so that the SOC in the charge is 70 to 80%. Consequently, the charge is continuously set for a long time. Thus, the relationship between the voltage of the battery and the SOC has high precision. Referring to the voltage of the battery which is lower than SOC 50% in the charge, the charge is carried out after the discharge in the charging/discharging state. Consequently, the charging state is set for a short period and the precision in the relationship between the voltage of the battery and the SOC is reduced. For this reason, the SOC 50% is set uniformly. In such a case, even if the second state-of-charge is uniformly set to be the SOC 50%, the weight of the second state-of-charge is small so that a great difference from an actual state-of-charge is made with difficulty. Thus, the SOC is estimated from the voltage by using the LUT on the discharge side in the measurement of the discharge current and the LUT on the charge side in the measurement of the charge current. Also in the same SOC, moreover, the voltage of the battery is varied depending on the temperature of the battery and the charge/discharge current value. Consequently, a plurality of LUTs to be varied depending on the temperature of the battery and the current value is used to calculate the SOC2.

FIG. 2 is a graph showing a relationship between the voltage of the battery and the state-of-charge. A voltage table on each point shown in FIG. 2 is separately prepared for both a temperature and a current. Moreover, Table 1 is an example of a table indicating the correspondence of the estimated value of a state-of-charge for each predetermined voltage of the battery. The table is prepared for each temperature and the Table 1 indicates the relationship of a correspondence between a charge current value and a state-of-charge at a battery temperature=0° C. as an example. When a charge current is 15 A and the voltage of the battery is 7.92 V at a battery temperature of 0° C., for example, the second residual quantity SOC2=90% is obtained. Data in the table are linearly interpolated and are thus used.

Moreover, it is also possible to utilize the graph for the voltage of the battery and the state-of-charge, the voltage table and the table for the voltage of the battery and the state-of-charge which correspond to a cumulative operating time. In the nickel hydrogen battery, when the cumulative operating time is gained, a voltage is raised in the same SOC.

TABLE 1

| SOC Current | 50% | 70% | 80% | 90% | 100% |
|---|---|---|---|---|---|
| 1 A | 7.39 V | 7.50 V | 7.56 V | 7.69 V | 7.84 V |
| 2 A | 7.45 V | 7.55 V | 7.62 V | 7.74 V | 7.90 V |
| 5 A | 7.50 V | 7.61 V | 7.68 V | 7.80 V | 7.96 V |
| 10 A | 7.55 V | 7.66 V | 7.73 V | 7.86 V | 8.02 V |
| 15 A | 7.60 V | 7.71 V | 7.79 V | 7.92 V | 8.09 V |
| 20 A | 7.65 V | 7.77 V | 7.84 V | 7.97 V | 8.25 V |

The synthetic SOC determined by synthesizing the two SOCs including the SOC1 calculated by the integration of a current and the SOC2 estimated by the voltage as described above is calculated by the weighted mean of the SOCs.

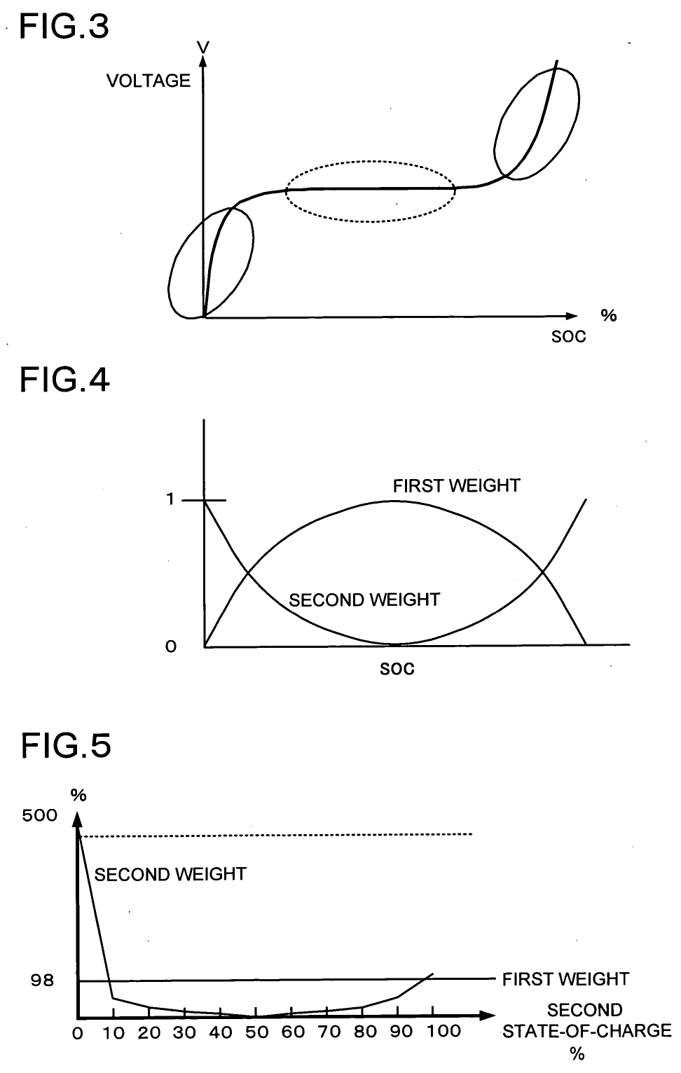

In general, the battery cannot uniquely determine the SOC with the voltage. More specifically, it has been known that a different voltage is indicated by a past charge/discharge history or the like also in the same SOC. In a high SOC region in charging, that is, a region in which a state-of-charge approximates to 100%, a low SOC region in discharging, that is, a region in which the state-of-charge approximates to 0%, precision is comparatively high and the SOC can be estimated from the voltage. On the other hand, in the vicinity of the state-of-charge of 50%, the SOC estimation based on the voltage has less reliability and a method of carrying out a correction and calculation in order to increase/decrease the state-of-charge by the integration of a current has higher precision. It is possible to estimate the SOC with high precision in the whole region of the capacity of the battery by a weighted mean taken by increasing the weighting of the SOC1 based on the integration of the current in the middle region of the SOC as shown in an ellipse in a broken line of FIG. 3 and increasing the weighting of the SOC2 based on the voltage in regions having high and low SOCs as shown in an ellipse in a solid line. In this method, moreover, it is necessary to prevent an overcharge and an overdischarge by a voltage in regions having high and low battery capacities. Consequently, the method is more advantageous to a safety as compared with the execution of a calculation depending on only the integration of a current.

(Weighting Factor)

FIG. 3 is a graph showing a region in which the first state-of-charge and the second state-of-charge are influenced in the calculation of the synthetic state-of-charge. This graph typically shows the relationship between the voltage of the battery and the state-of-charge. As shown in FIG. 3, a second weight to be a weighting factor related to the second state-of-charge is increased and a first weight to be a weighting factor related to the first state-of-charge based on the integration of the voltage is reduced in a region in which the second state-of-charge based on the voltage is predominant over the estimation of the state-of-charge. To the contrary, the first weight is increased and the second weight is reduced in a region in which the first state-of-charge is predominant over the estimation of the state-of-charge. FIG. 4 is a graph representing a relationship between the first weight and second weight and the state-of-charge in the case in which the synthetic state-of-charge is to be obtained. In FIG. 4, the first weight is represented as a convex waveform and the second weight is represented as a concave waveform, and the curves of the first weight and the second weight are almost inverted. In a region in which the second state-of-charge based on the voltage is predominant over the estimation of the state-of-charge, the second weight to be the weighting factor related to the second state-of-charge is increased and the first weight to be the weighting factor related to the first state-of-charge based on the integration of the voltage is reduced. FIG. 4 shows an example, and the first weight and the second weight can also be set independently. In general, the first weight is determined corresponding to the first state-of-charge and the second weight is determined corresponding to the second state-of-charge. FIG. 5 is a graph showing a relationship between the first weight and the second weight for the second state-of-charge according to another example. In this example, the first weight is set to have a constant value (uniformly 98% in this example), while the second weight is determined by referring to a table in the second state-of-charge which is calculated based on a preset table so as to be determined corresponding to the second state-of-charge. Also in FIG. 5, referring to a relative relationship between the first weight and the second weight, the second weight to be the weighting factor related to the second state-of-charge based on a voltage is increased and the first weight to be the weighting factor related to the first state-of-charge based on the integration of the voltage is reduced in the region in which the second residual region is predominant over the estimation of the state-of-charge.

(Synthetic State-of-Charge)

The synthetic state-of-charge is weighted corresponding to the first state-of-charge and the second state-of-charge and is calculated by multiplying them by a specific gravity and adding them. The specific gravity for the second state-of-charge is increased in a region in which the estimation of the state-of-charge based on the voltage seems to be reliable, that is, a region in which the capacity of the battery is large or small, and the specific gravity of the second state-of-charge is reduced and that of the first state-of-charge is increased in order to control the calculation of the synthetic state-of-charge based on the first state-of-charge through the integration of a current in other regions. As an example, the synthetic capacity can be calculated in the following equation.
Synthetic state-of-charge=((first state-of-charge*first weight)+(second state-of-charge*second weight))/(first weight+second weight)

In the relationship shown in FIG. 4, the first weight is the weighting factor of the first state-of-charge determined by the SOC1. In the relationship shown in FIG. 4, moreover, the second weight is the weighting factor of the SOC2 determined by the SOC2.

The synthetic state-of-charge can also have a through rate in order to control the state-of-charge so as not to fluctuate greatly by the calculation. The through rate can also be set individually in discharging and charging. For example, in the case in which there are a change of 1% or more in the discharging and a change of 0.5% or more in the charging from a last synthetic state-of-charge, the respective changes are controlled to be 1% and 0.5%.

(Correction of First State-of-Charge)

In the case in which a difference between the synthetic state-of-charge which is calculated and the first state-of-charge has a predetermined value, that is, the weighting factor of the second state-of-charge is maintained to be high and the first state-of-charge is not reflected by the synthetic state-of-charge, it is also possible to correct the first state-of-charge in order to cause the value of the first state-of-charge to approximate to the synthetic state-of-charge.

Furthermore, it is also possible to calculate the synthetic state-of-charge for each battery module constituting the battery unit 20 and to utilize a minimum synthetic state-of-charge as the state-of-charge of the battery unit 20. The state-of-charge thus calculated is transmitted from the connecting equipment communication terminal 30 to the vehicle side control portion through the communication processing portion 19.

Thus, it is possible to accurately predict the quantity of a power which can be utilized at each point during the charging and discharging by correctly grasping the state-of-charge of the battery. Consequently, it is possible to precisely control the quantity of the power and to utilize the battery safely and efficiently.

As this invention may be embodied in several forms without departing from the spirit or essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims. This application is based on Application No. 2004-297043 filed in Japan on Oct. 12, 2004, the content of which is incorporated hereinto by reference.

What is claimed is:

1. A method of detecting a state-of-charge of a battery which detects a state-of-charge of a battery included in a power device when supplying a power from the battery to connecting equipment connected to the power device, comprising the steps of:
detecting a current of the battery and a voltage of the battery;
calculating a state-of-charge of the battery as a first state-of-charge based on an integration of the current of the battery which is detected, while calculating the state-of-charge of the battery as a second state-of-charge based on the voltage of the battery; and
calculating, as a state-of-charge of the battery, a synthetic state-of-charge obtained by taking a weighted mean of the first state-of-charge and the second state-of-charge.

2. The method of detecting a state-of-charge of a battery according to claim 1, wherein the battery of which state-of-charge is to be calculated is a nickel hydrogen battery.

3. The method of detecting a state-of-charge of a battery according to claim 1, wherein a total voltage of the battery connected in series is detected to calculate the second state-of-charge.

4. The method of detecting a state-of-charge of a battery according to claim 1, further comprising the step of detecting a voltage of a battery module and calculating a second state-of-charge.

5. The method of detecting a state-of-charge of a battery according to claim 1, further comprising the step of accumulating a value obtained by multiplying a quantity of electricity calculated by multiplying a measured current value by a measuring time by a charge efficiency, and calculating the first state-of-charge.

6. The method of detecting a state-of-charge of a battery according to claim 1, wherein a weighted mean is weighted in such a manner that weighting of the second state-of-charge is increased in a region in which a capacity of the battery is large and a region in which the capacity of the battery is small, and weighting of the first state-of-charge is increased in other regions.

7. The method of detecting a state-of-charge of a battery according to claim 1, further comprising the step of:
detecting a measuring time of the current of the battery and a temperature of the battery,
the first state-of-charge being calculated by accumulating a value obtained by multiplying a quantity of electricity obtained by multiplying a battery current value by the measuring time by a charge efficiency determined by the temperature of the battery and a past state-of-charge.

8. The method of detecting a state-of-charge of a battery according to claim 1, wherein the second state-of-charge is determined by referring to a previously created table indicating a relationship between the voltage of the battery and the state-of-charge.

9. The method of detecting a state-of-charge of a battery according to claim 4, further comprising the step of:
detecting a temperature of the battery,
a plurality of different tables for determining the second state-of-charge being prepared corresponding to the temperature of the battery and/or a charge/discharge current value.

10. The method of detecting a state-of-charge of a battery according to claim 1, wherein a synthetic state-of-charge is calculated by taking a weighted mean in the following equation:
synthetic residual quantity=((first state-of-charge*first weight)+(second state-of-charge*second weight))/(first weight+second weight).

11. The method of detecting a state-of-charge of a battery according to claim 1, wherein connecting equipment is an on-vehicle motor and a state-of-charge of a battery included in a power device for driving the on-vehicle motor is detected.

12. A power device comprising:
a battery unit including a plurality of secondary batteries;
a voltage detecting portion for detecting a voltage of the secondary battery included in the power unit;
a temperature detecting portion for detecting a temperature of the secondary battery included in the power unit;
a current detecting portion for detecting a current flowing to the secondary battery included in the battery unit;
a state-of-charge calculating portion for calculating signals to be input from the voltage detecting portion, the temperature detecting portion and the current detecting portion and detecting a state-of-charge of the secondary battery; and
a communication processing portion for transmitting the state-of-charge calculated by the state-of-charge calculating portion to connecting equipment,
the state-of-charge calculating portion increasing weighting of a second state-of-charge in a region in which a state-of-charge is increased and a region in which the state-of-charge is reduced and increasing weighting of a first state-of-charge in other regions when integrating the charge/discharge current detected by the current detecting portion to calculate a first state-of-charge, while calculating a second state-of-charge based on the voltage of the battery which is detected by the voltage detecting portion and taking a weighted mean of the first state-of-charge and the second state-of-charge to calculate a synthetic state-of-charge as the state-of-charge of the battery.
